(19) United States
(12) Patent Application Publication
(10) Pub. No.: US 2009/0175458 A1
(43) Pub. Date: Jul. 9, 2009

(54) Subwoofer docking station

(76) Inventor: Kelly Smith, Cypress, CA (US)

Correspondence Address: LAW OFFICES OF CLEMENT CHENG, 17220 NEWHOPE STREET #127, FOUNTAIN VALLEY, CA, 92708, US

(21) Appl. No.: 12/008,191

(22) Filed: Jan. 9, 2008

(51) Int. Cl. H04R 5/00

(52) U.S. Cl. 381/28

(57) ABSTRACT

A subwoofer stereo system with a docking base for docking a portable digital media player comprises a generally hexahedron cabinet made of a panel material for encasing at least an electronic media processing unit and an amplifier for driving stereo speakers. The docking base has an attachment of modular connector board having at least one main connector for the portable digital player and at least one auxiliary phone plug. The docking base is mounted through the top panel extending in part inwardly of the cabinet as well as outwardly in part for receiving the portable player. A first shielding chamber extends from under the top panel invisibly to enclose the inward part of the docking base to isolate it from interior of the cabinet and a second shielding chamber extends from behind under the front panel invisibly to enclose the control interface to isolate it from interior of the cabinet.

### BACKGROUND OF THE INVENTION

A. Field of the Invention

The present invention relates to a subwoofer media system. More particularly, the present invention relates to a portable digital music player docking station optimally integrated into a main media system complete with an integral subwoofer.

B. Description of the Prior Art

Along with the wide spread use of the digital audio players such as the most popular iPod series of Apple Computer, Cupertino, Calif., different docking stations came to be able to interface such portable devices for a high fidelity media playback through a more sophisticated media system. International Application No. PCT/US2004/008686 by Apple Computer titled Media Player System shows extensive examples of the interface including a boom box with a built-in docking station, the disclosure of which is incorporated herein by reference. However, besides the electrically correct pin designation between the portable media device and the boom box, no suggestions have been made as to an acoustically conscious integration of the docking station into the boom box or higher powered audio systems built in advanced speaker cabinets.

Commonly, a home theater in a box is a name for an integrated home entertainment product, usually including surround sound capability and a radio tuner in one convenient box with or without a DVD player. Such a home theater generally consists of a central receiver unit, a radio tuner and a series of speakers for surround sound reproduction, generally including a subwoofer in dedicated speaker enclosures. The theater box does not need an acoustic consideration in construction but the correct volume and mount for electronic circuitry with an easy and aesthetic interface would be suffice. Such a system may have a separate large subwoofer (low frequency) in addition to five surrounding component speakers that comprise a matched tweeter (high frequency) and midrange (medium frequency) speakers. The subwoofer is provided for bass and sub bass (ultra low frequency), which is felt more than heard depending on the sub frequency. The lower the frequency the less the human ear picks it up, however the vibration can be felt greater. Sub bass is omni-directional, meaning that the human ear cannot distinguish where the sound is coming from but can feel it in the form of vibrations through air. Therefore, in order to physically as well as electrically connect a portable digital player to a complete system under the influence of the subwoofer operation a reconsideration in the structure of the cabinet is necessary to ensure an uninterrupted sound production from the docked digital player.

Yet, known docking stations are made to simply fit in an appropriately sized hole on the wall of the subwoofer stereo system to support a smaller circuit board, which in turn support audio/video plugs and/or pin connectors so that they are readily mated with compatible portable media players to relay their outputs. Correctly fitting a docking station might serve the purpose with respect to a boom box or similar subwoofer stereo system where two-channel audio is produced. However, for high-end audio systems made for five channels of amplification necessary to reproduce 5.1 surround sound with greater volume and reality of sound, an advanced material and structure must be applied for the enclosure and thus an improved docking station is necessary in terms of construction and integration. Besides the proprietary pin designations between the boom box, suggestions for improvement are slim to none with respect to these omnipresent iPod players as to an acoustically conscious integration of an appropriate docking station into a high power audio system with an onboard subwoofer.

In contrast with conventional receivers, the present invention provides an even compact media system containing all the major components in a central subwoofer cabinet except five satellite speakers of the 5.1 surround speaker set. It only needs separate state of the art units of DVD player and television set or monitor with which to display the visual material to fully appreciate the theatrical level of audio/visual entertainment.

An object of the present invention is to provide an improved media system with the necessary docking base for iPod devices in an acoustically integrated enclosure for docking the portable digital media player in order to take advantage of the advanced audio technology currently available.

### SUMMARY OF THE INVENTION

A subwoofer stereo system with a docking base for docking a portable digital media player comprises a generally hexahedron cabinet made of a panel material for encasing at least an electronic media processing unit and an amplifier for driving stereo speakers. The cabinet has a front panel with a predetermined shape of cut out for framing a control interface of the subwoofer stereo system and a display of the status of system operation, a rear panel for holding a cluster of connectors for external devices, two opposite sidewall panels, a bottom speaker panel elevated by legs from a floor and having a large central opening, and a top panel.

The docking base has an attachment of modular connector board having at least one main connector for the portable digital player and at least one auxiliary phone plug. The docking base is mounted through the top panel extending in part inwardly of the cabinet as well as outwardly in part for receiving the portable player. A first shielding chamber extends from under the top panel invisibly to enclose the inward part of the docking base to completely isolate the same from interior of the cabinet and a second shielding chamber extends from behind under the front panel invisibly to enclose the control interface to completely isolate the same from interior of the cabinet.

Embodiments of the invention will now be described by way of example with reference to the accompanying drawings.

### BRIEF DESCRIPTION OF THE DRAWINGS

FIG. 1 is a front elevational view of a media system with docking station according to the present invention.

FIG. 2 is a bottom view of the media system of FIG. 1 showing a subwoofer installed inside the media system.

FIG. 3 is a rear elevational view of the media system of FIG. 1.

FIG. 4 is an exploded perspective view of the docking station in operation according to the present invention.

FIG. 5 is a side elevational view of the media system of FIG. 1 showing the positions of major components inside with the dock station closed.

FIG. 6 is a perspective view of the media system of FIG. 1 showing the structure of a top shield room for the docking station.

Similar reference numbers denote corresponding features throughout the attached drawings.

### DETAILED DESCRIPTION OF THE PREFERRED EMBODIMENT

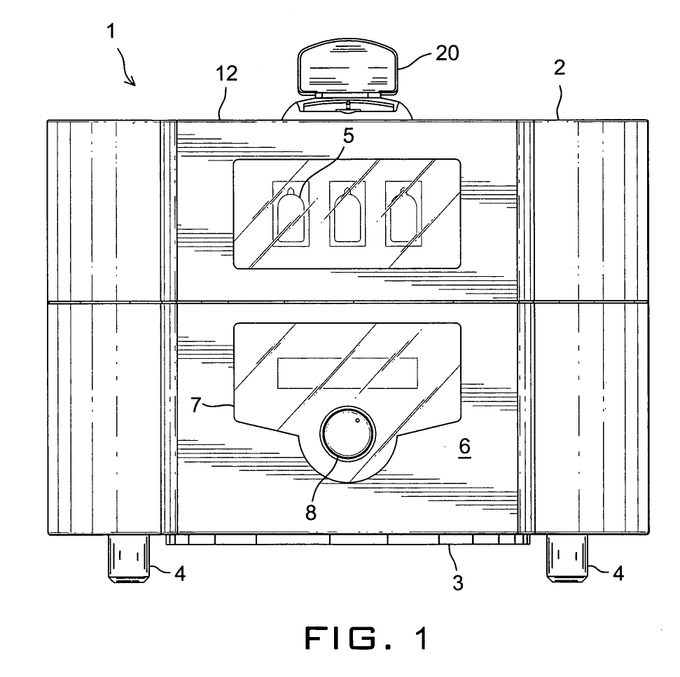

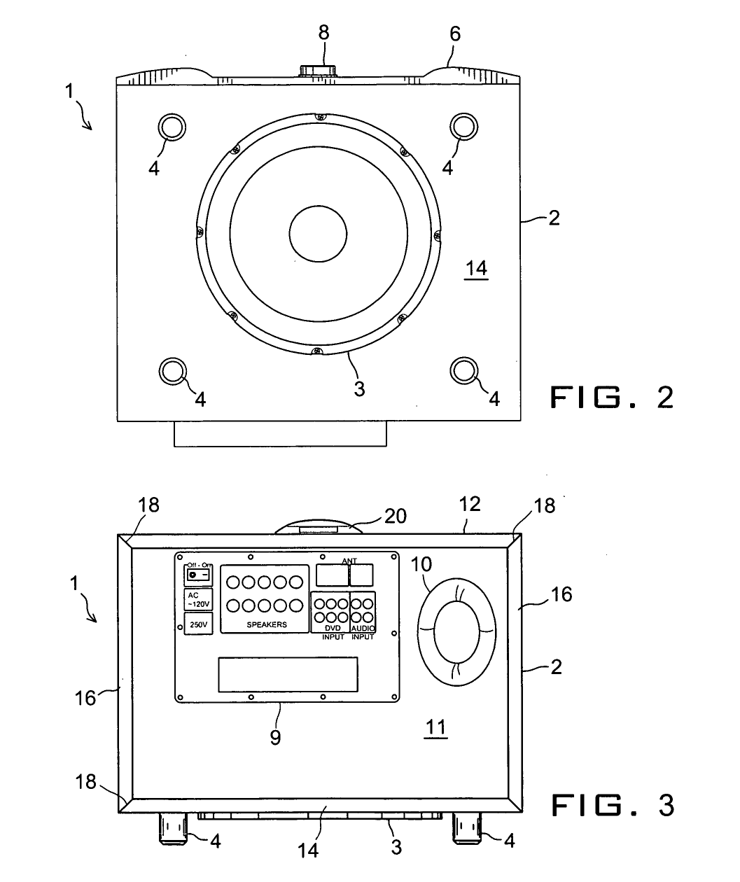

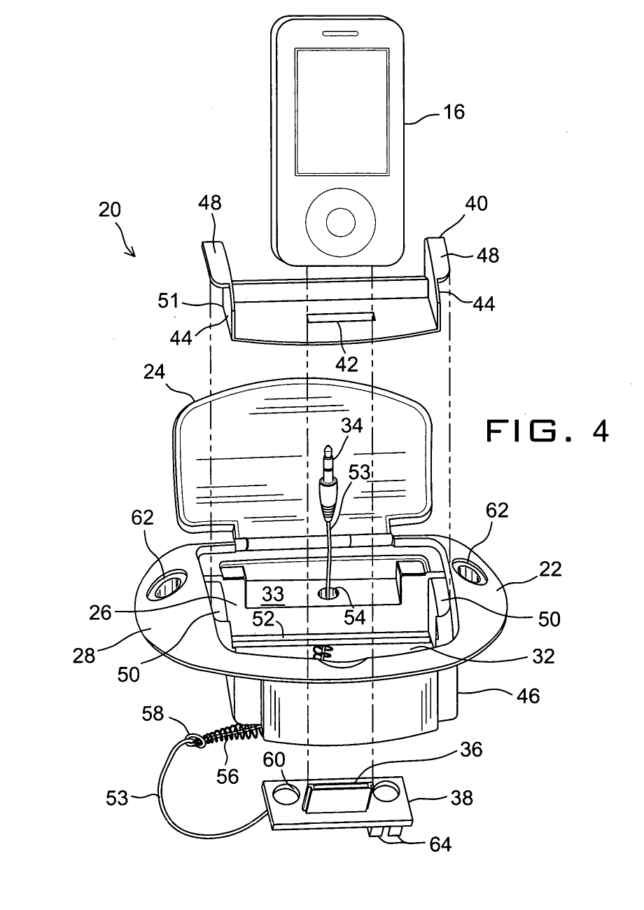

With reference to FIGS. 1-3, a media system 1 is home entertainment components in a cabinet 2 that contains an integrated bottom subwoofer 3 held from a floor a short distance by four legs 4, a digital 5.1 audio/video receiver and AM/FM tuner partially visible at 5 through a front panel 6 and interfacing at a display 7 with a volume knob 8 for adjusting reproduced music and speech from a conventional A/V gear including DVD and CD players connected to a cluster 9 for plug and play operations. From rear view of FIG. 3, Next to cluster 9 is provided an oval port 10 for the bass reflex within a hole formed through a back panel 11. The bass reflex port 10 is preferably 10 cm deep. The front panel further includes a remote control receiver, such as an infrared receiver for receiving signals from a remote control device. The AM/FM tuner 5 preferably has a plurality of tube lights that are either aesthetic or functional. Preferably, the tube lights are functional. The tube lights can be seen through a window disposed in the front face of the cabinet. The window preferably has a transparent plastic cover for protecting the tube lights.

The cabinet is also housing an amplifier that is connected to the radio receiver. The amplifier preferably has an approximately 1000 W power rating. The material of the cabinet can be pressed fiberboard, and is preferably made of wood, although it could be made of a plastic material. The substructure of the cabinet is preferably made of the same material as the exterior top, front, back, left, right, bottom faces. The substructure elements preferably have an airtight seal so that the cabinet does not have sonic leaking through the substructure elements 70, 72.

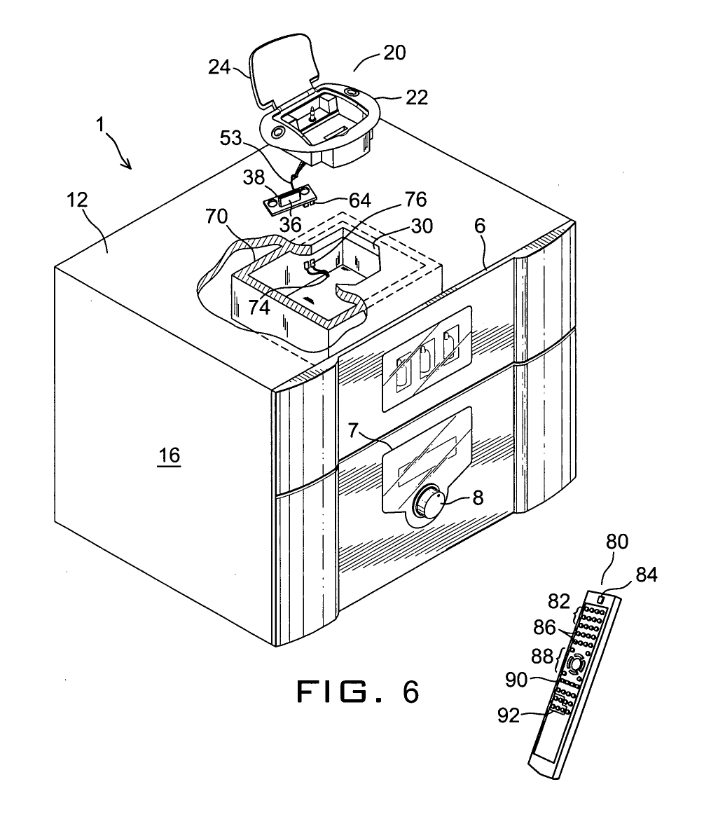

The cabinet 10 has a top panel 12 and bottom panel 14 that are joined by two parallel side panels 16 at 45-degree angle to provide a longer bonding area at four joints 18. Mounted on the top panel 12 of system 1 is a closable media dock 20, which comprises a shell base 22 and a spring biased lid 24. Media dock 20 may be made of a thermoplastic material utilizing a conventional molding process. Dock 20 has a generally rectangular cavity 26 for accommodating various sizes of MP3 players. Dock 20 also has a round collar 28 to support itself against the upper side of top panel 12 having a large bore 30 (FIG. 6) covered by collar 28 from an external view. Cavity 26 may be divided to have a larger bay 32 for receiving an iPod 16 with a thirty-pin female connector (not shown) and a stepped stage 33.

The spring biased lid 24 has two toggled positions to either expose or cover a phone plug 34 and a 30-pin male connector 36 on board 38 and a cradle insert 40 with an appropriately sized rectangular hole 42 to permit the connector 36 to protrude at an angled position so that iPod unit 16 with mating female connector docks into open shell base 22 making the 30-pin connection with male connector 28 in a convenient leaning posture. Insert 40 may be attached to shell base 22 by forming protrusions at sidewalls 44 of insert 40 and opposing notches at corresponding areas on walls 38 of base 22. Upon assembly, top side flaps 48 of cradle insert 40 are laid flat on shoulders 50 formed on base 22 while a rear edge 51 of insert 40 is placed on a sill 52.

While angularly supporting connector 36, board 38 also holds terminals of lead wires 53 of plug 34 for making connection to MP3 player models with an audio jack. In order to provide the necessary connections with flexibility for different dimensions of most media players, phone plug 34 may be retracted out of a conical support 54 formed on stage 33 of shell base 22 where the cone 54 opens upwardly to receive plug 26 normally under a withdrawing bias from a concentrically mounted spring 56. Spring 56 may be generally shaped into an inverted cone to surround the downwardly protruding cone 54 and is simply lodged between knots 58 tied midway along the lead wires 53 and the cone 54 of base 22. Although not detailed, underside of base 22 may have mounting posts for holding board 38 at two thru holes 60 that are positioned over the posts with appropriate elastic rings threaded therebetween so that screw fasteners are driven over board 38 into the posts to affix the parts together permanently.

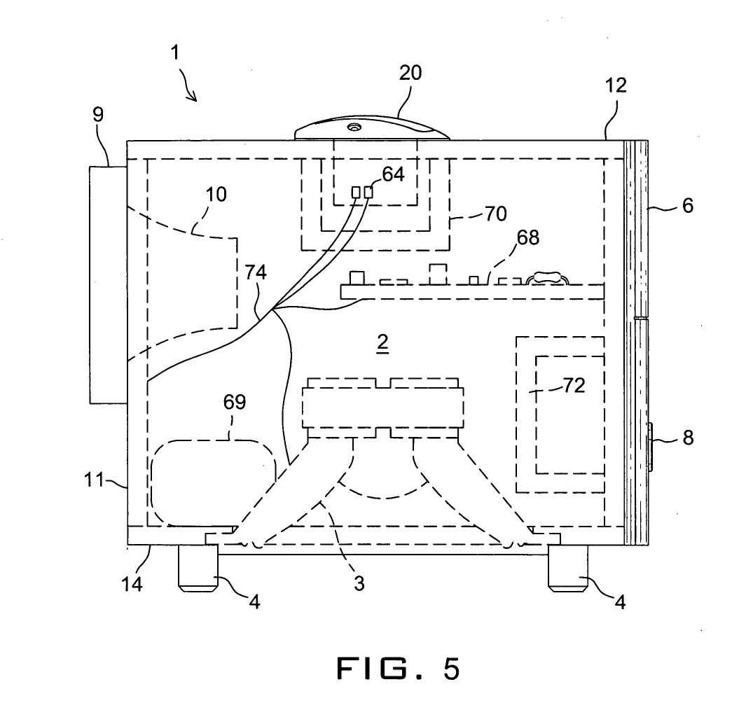

In addition, collar 28 of shell base 22 has main screw bores 62 at two sides for mounting on top panel 12 of system 1. Therefore, media dock 20 on system 1 comes to provide the rigid connector 36 along with the flexible phone plug 34 to add the versatility of media system 1. The board 38 has terminal connectors 64 that interconnect with connector cluster 9 as well as a main board 68 as shown in FIG. 5. Also depicted next to subwoofer 3 is a transformer 69 for supplying electric power.

Referring further to FIG. 6, media dock 20 below the collar 28 is housed in the interior of cabinet 2 but it is completely isolated by a top shield box 70 made of the same thick and sturdy panel material as cabinet 2. Shield box 70 is strongly glued to a lower surface of top panel 12 about bore 30. Cabinet 2 may be made of conventional material based on wood, particle board, plywood panels or other composite material cut and glued together to form an enclosure for the receiver/tuner circuitry on the main board 68 as well as subwoofer 3, which is mounted to a large opening formed on the bottom panel 12 of cabinet 2.

For the general construction of cabinet 3 the material of choice may be a particleboard, which is a solid wood composite product. Along with flakeboard and other engineered lumbers, composite products are made from wood flakes, chips, splinters, etc., formed into layers and held together by resin glues and heated under pressure. In order to give a smooth texture to the final product, cut panels of particleboard are provided with a resin impregnated paper coating.

In particular, front panel 6 may be decorated with as additional piano black lacquer finish to improve aesthetics of the system 1. In order to further improve the sound quality from the same structure of system 1, panels made of MDF (medium density fiberboard) may be chosen. MDF belongs to the hardboard products which are made from wood fibers glued under heat and pressure. MDF is very well damped acoustically for this particular configuration thus making it an ideal material for speaker enclosures besides its uniform texture. It makes excellent panels for mounting high power speakers such as subwoofer 3.

When assembled using the material of choice in the structure described, cabinet 2 is divided into three isolated interior sections comprising a main cavity that occupies most of the inner space of the cabinet 2 where the receiver/tuner circuitry on main board 68 projects from a mount (not shown) on front panel 6, top shield box 70 and a front shield box 72 that seals the front panel components for display 7 completely against the inner surface of front panel 6. Although not shown, the cabinet 2 is further braced with cut panels at every corner inside the main cavity for enhancing rigidity and thus the undistorted sound production from the whole sound box of media system 1. To provide isolated electrical connections, shield box 70 is thoroughly glued to a lower surface of top panel 12 about bore 30 leaving only a tiny path 74 communicating with cabinet 3 interior for wire terminals 76 from main board 68. The wire path 74 is subsequently sealed airtight using glue filling.

Top and front shield boxes 70, 72 assist in obtaining the full body of amplified audio immediately from the onboard subwoofer 3 and the satellite surround sound loud speakers through electrically shielded means of output wires 76.

The entire operation of the media system 1 is controlled using a remote control unit 80 that holds total forty six input keys grouped into major functions of the media system 1. I.e., a tuner band selector region 82 is conveniently located at a leading end of remote 80 and has twelve evenly spaced key dots for selecting that number of memorized radio channels. A detached button 84 is a standby control selector. Next come volume keys including eight key dots 86 for selecting rear left channel volume up and down, center channel volume up and down, rear right channel volume up and down, and subwoofer volume up and down, respectively. In the middle is a main sound control 88 including a central mute button, treble up and down selectors, bass up and down selectors, master volume increase and decrease controls, and left and right balance selectors.

Lastly, among other input selectors an MP3/iPod source input selector 90 is located at the first row next to the main control 88 and provided with a submenu 92 having an iPod-last control selector, next control selector, backward control selector, forward control selector, and play-pause control selector.

The media system 1 is particularly suited to dock a portable digital player that is the wide spread iPod portables capable of holding multi-gigabytes of music and A/V files from a computer storage or other external digital media devices and further comprises a set of five surround sound speakers (not shown) that plug into the rear connection cluster 9 and mounted around room walls to provides a realistic audio reproduction.

As with many ‘third party’ makers' devices for connection with Apple Computer products, the media system 1 may incorporate the iPod Accessory Serial Protocol as detailed in U.S. Pat. No. 7,293,122 in order to communicate with iPod players. And the known connector pin designations for a docking connector are herein incorporated for the sake of an immediate reference. The actual small, rectangular terminal connector as connector 36 is now widely used to connect a full sized iPod to another device and is often called a “30-Pin Connector”.

The pins of the connector are known with input/output being designated as follows:

### Pin#/Functions

1. I Digital Ground

2. I Digital Ground

3. I/O Firewire signal TPA (+)

4. I/O USB signal (+)

5. I/O Firewire signal TPA (−)

6. I/O USB signal (−)

7. I/O Firewire signal TPB (+)

8. I USB VBUS Power +5 VDC (from computer)

9. I/O Firewire signal TPB (−)

10. I Accessory Indicator

11. I Firewire Power 8V—30VDC

12. I Firewire Power 8V—30VDC

13. O +3.3V Power (to power accessories)

14. Reserved

15. GND Digital ground in iPod

16. GND Digital ground in iPod

17. Reserved

18. I Serial protocol (Data to iPod)

19. O Serial protocol (Data from iPod)

20. I/O Accessory Detect

21. O S-Video Luminance, Component Y

22. O S-Video Chrominance, Component C

23. O Video Out—Composite Video

24. I Detect remote

25. I Line In—Left

26. I Line In—Right

27. O Line Out—Left

28. O Line Out—Right

29. GND Line Out—Common Ground

30. GND Digital ground iPod

31. Chassis ground for connector shell

32. Chassis ground for connector shell

Some of these pins can be omitted, and it is preferred to have less than all of the pins such as those which are disclosed in US patent publication 2007/0028006 published Feb. 1, 2007, the disclosure which is incorporated herein by reference. For example, the FireWire pins and the USB and video pins can be omitted by not having a connection to the circuit board so that there is only operational pins as follows:

### 10. I Accessory Indicator

15. GND Digital ground in iPod
16. GND Digital ground in iPod
18. I Serial protocol (Data to iPod)

### 20. I/O Accessory Detect

24. I Detect remote

### 25. I Line In—Left

### 26. I Line In—Right

Therefore, while the presently preferred form of the media system with docking station in complete isolation has been shown and described, and several modifications thereof discussed, persons skilled in this art will readily appreciate that various additional changes and modifications may be made without departing from the spirit of the invention, as defined and differentiated by the following claims.

1. A subwoofer stereo system with a docking base for docking a portable digital media player comprising:
a generally hexahedron cabinet made of a panel material for encasing at least an electronic media processing unit and an amplifier for driving stereo speakers, the cabinet having a front panel with a predetermined shape of cut out for framing a control interface of the subwoofer stereo system and a display of the status of system operation, a rear panel for holding a cluster of connectors for external devices, two opposite sidewall panels, a bottom speaker panel elevated by legs from a floor and having a large central opening, and a top panel;
the docking base having an attachment of modular connector board having at least one main connector for the portable digital player and at least one auxiliary phone plug, the docking base being mounted through the top panel extending in part inwardly of the cabinet as well as outwardly in part for receiving the portable player;
a first shielding chamber extending from under the top panel invisibly and enclosing the inward part of the docking base to isolate the same from interior of the cabinet and a second shielding chamber extending rearward of the front panel invisibly and enclosing the control interface to completely isolate the same from interior of the cabinet; and
a radio receiver electronically connected to the electronic media processing unit and amplifier, for receiving radio signals and playing them through the subwoofer mounted on a bottom face of the subwoofer stereo system.

2. The subwoofer stereo system of claim 1 having a docking base, wherein the first and second shielding chambers are made of particleboard that is used to construct the cabinet panels, further comprising an amplifier having at least 1000 W of power mounted next to the subwoofer.

3. The subwoofer stereo system of claim 1 having a docking base, wherein the first and second shielding chambers are made of medium density fiberboard that is used to construct the cabinet panels.

4. The subwoofer stereo system of claim 1 having a docking base, wherein the docking base comprises a shell base, a cradle insert and a spring biased lid all of which are made of a thermoplastic material, the docking base having a generally rectangular cavity for accommodating various sizes of MP3 players, a round collar to support itself against the top panel through a large bore formed on the top panel covered by the collar from an external view, the cavity having a larger bay for receiving the MP3 players with a female connector and a stepped stage, the spring biased lid having two toggled positions to either expose or cover the main connector or phone plug, the cradle insert having a predetermined size of a rectangular hole to permit the main connector to protrude at an angled position so that the MP3 player with a mating connector docks into open shell base making connection with the main connector in a convenient leaning posture, the cradle insert being attached to the shell base by protrusions formed on sidewalls of the cradle insert and opposing notches at corresponding areas on the shell base.

5. The subwoofer stereo system of claim 1 having a docking base, wherein the radio receiver includes a plurality of tube lights mounted on a top surface of a main board, wherein the tube lights can be seen through a window disposed in the front face of the cabinet, wherein the window has a transparent plastic cover for protecting the tube lights.

6. A subwoofer stereo system having a docking base for docking a portable digital media player comprising:
a generally hexahedron cabinet made of a panel material for encasing at least an electronic media processing unit and an amplifier for driving stereo speakers, the cabinet having a front panel with a predetermined shape of cut out for framing a control interface of the subwoofer stereo system and a display of the status of system operation, a rear panel for holding a cluster of connectors for external devices, two opposite sidewall panels, a bottom speaker panel elevated by legs from a floor and having a large central opening, and a top panel;
the docking base having an attachment of modular connector board having at least one main connector for the portable digital player and at least one auxiliary phone plug, the docking base being mounted through the top panel extending in part inwardly of the cabinet as well as outwardly in part for receiving the portable player;
a first shielding chamber extending from under the top panel invisibly and enclosing the inward part of the docking base to isolate the same from interior of the cabinet and a second shielding chamber extending rearward of the front panel invisibly and enclosing the control interface to isolate the same from interior of the cabinet,
wherein the docking base has at least the following pins for connecting with a portable media player: Accessory Indicator, Power Pins, Digital ground, Serial protocol, Accessory Detect, Detect remote, Line Out Left and Right
further comprising a remote control for controlling the portable media player via a remote control receiver electrically connected to the control interface of the subwoofer stereo system; and
a radio receiver electronically connected to the electronic media processing unit and amplifier, for receiving radio signals and playing them through the subwoofer.

7. A subwoofer stereo system according to claim 6, further comprising: input selectors on the remote control including: a MP3/iPod source input selector, a submenu having a last control selector, next control selector, backward control selector, forward control selector, and play-pause control selector.

8. The subwoofer stereo system of claim 7, wherein the first and second shielding chambers are made of particleboard that is used to construct the cabinet panels, further comprising an amplifier having at least 1000 W of power mounted next to the subwoofer.

9. The subwoofer stereo system of claim 7, wherein the first and second shielding chambers are made of medium density fiberboard that is used to construct the cabinet panels, further comprising an amplifier having at least 1000 W of power mounted next to the subwoofer.

10. The subwoofer stereo system of claim 7, wherein the docking base comprises a shell base, a cradle insert and a spring biased lid all of which are made of a thermoplastic material, the docking base having a generally rectangular cavity for accommodating various sizes of MP3 players, a round collar to support itself against the top panel through a large bore formed on the top panel covered by the collar from an external view, the cavity having a larger bay for receiving the MP3 players with a female connector and a stepped stage, the spring biased lid having two toggled positions to either expose or cover the main connector or phone plug, the cradle insert having a predetermined size of a rectangular hole to permit the main connector to protrude at an angled position so that the MP3 player with a mating connector docks into open shell base making connection with the main connector in a convenient leaning posture, the cradle insert being attached to the shell base by protrusions formed on sidewalls of the cradle insert and opposing notches at corresponding areas on the shell base.

11. The subwoofer stereo system of claim 7, wherein the radio receiver includes a plurality of tube lights mounted on a top surface of a main board, wherein the tube lights can be seen through a window disposed in the front face of the cabinet, wherein the window has a transparent plastic cover for protecting the tube lights.

12. The subwoofer stereo system of claim 7, wherein the first and second shielding chambers are made of particleboard or medium density fiberboard which is also used to construct the cabinet panels, further comprising an amplifier having at least 1000 W of power mounted next to the subwoofer.

13. The subwoofer stereo system of claim 7, wherein the docking base comprises a shell base, a cradle insert and a spring biased lid all of which are made of a thermoplastic material, the docking base having a generally rectangular cavity for accommodating various sizes of MP3 players, a round collar to support itself against the top panel through a large bore formed on the top panel covered by the collar from an external view, the cavity having a larger bay for receiving the MP3 players with a female connector and a stepped stage, the spring biased lid having two toggled positions to either expose or cover the main connector or phone plug, the cradle insert having a predetermined size of a rectangular hole to permit the main connector to protrude at an angled position so that the MP3 player with a mating connector docks into open shell base making connection with the main connector in a convenient leaning posture, the cradle insert being attached to the shell base by protrusions formed on sidewalls of the cradle insert and opposing notches at corresponding areas on the shell base.

14. The subwoofer stereo system of claim 13, wherein the radio receiver includes a plurality of tube lights mounted on a top surface of a main board, wherein the tube lights can be seen through a window disposed in the front face of the cabinet, wherein the window has a transparent plastic cover for protecting the tube lights.

15. The subwoofer stereo system of claim 13, wherein the docking base has a plurality of pin assignments which include: pin number 10 providing an input of an accessory indicator signal, pin number 15 providing a digital ground, pin number 18 providing a serial protocol for data transmission to the media player, pin number 20 providing an accessory detection signal, and pin number 24 providing remote control detection signal, pin number 25 providing a line signal for a left speaker, and pin number 26 providing a line signal for a right speaker.

16. The subwoofer stereo system of claim 15, wherein the first and second shielding chambers are made of particleboard or medium density fiberboard which is also used to construct the cabinet panels.

17. The subwoofer stereo system of claim 15, wherein the cabinet has a top panel and bottom panel that are joined by two parallel side panels at a 45-degree angle to provide a longer bonding area at four joints, wherein the top panel is a closable media dock which comprises a shell base and a spring biased lid, wherein the media dock is made of a thermoplastic material utilizing a conventional molding process.

18. The subwoofer stereo system of claim 15, wherein the dock has a generally rectangular cavity for accommodating various sizes of MP3 players, wherein the dock also has a round collar to support itself against the upper side of the top panel having a large bore covered by the collar.

19. The subwoofer stereo system of claim 15, wherein the dock has a generally rectangular cavity for accommodating various sizes of MP3 players, wherein the cavity is be divided to have a larger bay for receiving an iPod with a thirty-pin female connector and a stepped stage.
